(19) United States
(12) Patent Application Publication
(10) Pub. No.: US 2008/0301456 A1
(43) Pub. Date: Dec. 4, 2008

(54) Efficient Secure Forensic Watermarking

(76) Inventors: Antonius Adriaan Maria Staring, Eindhoven (NL); Aweke Negash Lemma, Eindhoven (NL); Minne Van Der Veen, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 12/097,522

(22) PCT Filed: Dec. 15, 2006
(86) PCT No.: PCT/IB06/54881

§ 371 Date: Jun. 14, 2008

(30) Foreign Application Priority Data
Dec. 22, 2005 (EP) 05112768.6

(51) Int. Cl. H04L 9/06

(52) U.S. Cl. 713/176

(57) ABSTRACT

The invention relates to a watermark generation method for generating watermarks to be embedded in digital media, where said watermark is generated by combining at least two watermark patterns from a set of watermark patterns. The set of watermark patterns are divided into at least two subsets of watermark patterns, and the subsets are hierarchically related and the watermark patterns in said watermark are directly related watermark patterns. Directly related means that the watermark patterns are related like parent and child in a hierarchical structure e.g. a tree structure. Further, the invention relates to an apparatus adapted to generate watermarks to be embedded in media.

### FIELD OF THE INVENTION

The present invention relates to methods for applying forensic watermarks to media and methods for identifying media through the forensic watermarks.

### BACKGROUND OF THE INVENTION

Owners and producers of media (e.g. music, movies or software) often distribute their work to consumers through a copy-protected optical disk (e.g. a DVD). This ensures the owners that the consumers do not copy and illegally distribute the work without the owners getting proper payment. However, many consumers desire to make copies of the work that they have legally acquired on a copy-protected optical disc, such as a DVD. Content owners and/or state law may grant consumers the right to make copies as long as those copies are for personal use only. Preferably, such copies should also play on “legacy” equipment or formats, such as PCs, CD-R discs and mp3-players, which do not support any copy protection system. In order to limit the distribution of the (in that case) unprotected copies, it has been proposed to embed forensic watermarks in the copies. The purpose of forensic watermarks is to enable identification of individuals making the original (first generation) copies. It is expected that the presence of those watermarks will deter consumers from distributing their copies on the Internet. However, it has been questioned whether a forensic watermark can provide conclusive proof as to who would ultimately be responsible for rogue copies that appear on the Internet.

Typically, the consumer's player or recorder (hereafter called the client device) has to embed the forensic watermark in the copy. For this purpose the client device uses an internally stored watermark pattern and provides the consumer's identity as the watermark payload. In this setup all client devices share the same fixed watermark pattern. Eventually a skilled hacker may be able to extract the watermark pattern from a client device as well as the method that is used to construct its (optional) payload. In addition, the hacker may codify this knowledge in a software tool and publish it on the Internet. This tool enables anyone (skilled or unskilled) to embed any watermark carrying any payload. As a result, the watermark no longer provides conclusive proof as to who made the copy and the person responsible for the illegal distribution cannot be found.

Revealing the watermark pattern, which is a global secret known by all client devices, represents a catastrophic failure of the system. The risk that the watermark pattern would be revealed is high when all client devices know how the watermark pattern is constructed, which is typically done by modulating a certain basic watermark pattern. A skilled hacker could easily get access to a client device and thereby hack the device. Furthermore, the so-called collusion attack where a number of traitors collaborate in order to hack the watermarking system is a problem. A number of multiple individuals get hold of the basic pattern and thus could collaborate to jointly defeat the system. Once the basic pattern is known the whole system is compromised, and it is therefore impossible to track illegal copies back to the traitor. The solution is to use independent basic patterns for each copy. However, the problem of this approach is that detection of the traitor becomes too complex as it would require searching all possible patterns.

### OBJECT AND SUMMARY OF THE INVENTION

It is a goal of this invention to improve upon the above.

The invention discloses a watermark generation method for generating watermarks to be embedded in digital media, where said watermark is generated by combining at least two watermark patterns from a set of watermarks patterns. The set of watermark patterns is divided into at least two subsets of watermark patterns, and the subsets are hierarchical related. Hereby a watermark is generated from hierarchical related watermark patterns which make it easier to identify a watermark from different watermarks. Furthermore, different watermarks could be generated because the watermark consists of different watermark patterns that could be combined in different ways. This is an advantage when a unique watermark has to be embedded in a copy of a media.

In one embodiment of the watermark generation method, the watermark patterns in said watermark are directly related watermark patterns, and the watermark patterns in said watermark are directly related watermark patterns. Directly related means that the watermark patterns are related like parent and child in a hierarchical structure, e.g. a tree structure. The direct relation between the watermark patterns makes it possible to make a structured search strategy. The hierarchical structure limits the search results very fast because first the top watermark pattern (the parent) is found, and thereafter the search is limited to the watermarks patterns (the children) directly related to the top watermark.

In one embodiment of the watermark generation method, the watermark patterns in each of the subsets are mutually independent. This makes it more difficult for a hacker to overcome the watermark system and thus illegal distribution of the copies is limited.

In a further embodiment of the watermark generation method, the watermark patterns in at least one subset is generated by modulating a given basic pattern by a payload, and at least one watermark pattern from said subset is used in the generation of said watermark. This makes the search strategy even faster as the top watermark pattern can easily be found from the payloads.

In a further embodiment of the watermark generation method only one watermark pattern from each subset is used to generate said watermark. This ensures that only one watermark pattern from each level in the hierarchy is used to generate the watermark, and the result is that the search strategy is improved because it can be performed from top to bottom of the hierarchy.

In a further embodiment of the watermark generation method, each combination of said watermark patterns is used only once in order to generate a unique watermark. It is hereby possible to embed a unique watermark in every copy made of the media, and the result is that every copy can be uniquely identified.

Further, the invention relates to an apparatus for generation of watermarks to be embedded in digital media, where said apparatus comprises generation means for generation of a watermark as described above. Hereby a watermark can be generated from direct hierarchical related watermark patterns, thus making it easier to identify a watermark form different watermarks, and because of the direct relation between the watermark patterns a structured search strategy can be made. The hierarchical structure limits the search results very fast because first the top watermark pattern is found and thereafter the search is limited to the watermark patterns directly related to the top watermark.

In an embodiment the apparatus described above further comprises embedding means where said embedding means is adapted to embed said generated watermark in digital media. This ensures that the watermark can be integrated in a copy of the media and the watermark can later be extracted from the copy, and the copy can then be traced back to the consumer that made the copy.

In an embodiment the apparatus further comprises storing means, and said storing means is adapted to store said watermark. This ensures that the watermark can be stored in e.g. a database together with information of which consumer made which copy. Thereby the responsible consumer can be found in the case of illegal distribution of the copy.

### BRIEF DESCRIPTION OF THE DRAWINGS

In the following preferred embodiments of the invention will be described referring to the figures, where

FIG. 1 illustrates an explanatory flow diagram of how the invention could be implemented,

FIG. 2 illustrates an explanatory flow diagram of what eventually happens when a consumer has obtained a copy of media,

FIG. 3 illustrates how the unique watermarks could be structured in an organised way,

FIG. 4 illustrates an embodiment of how the unique watermarks could be structured from one basic watermark sequence carrying different payloads.

### DESCRIPTION OF PREFERRED EMBODIMENT

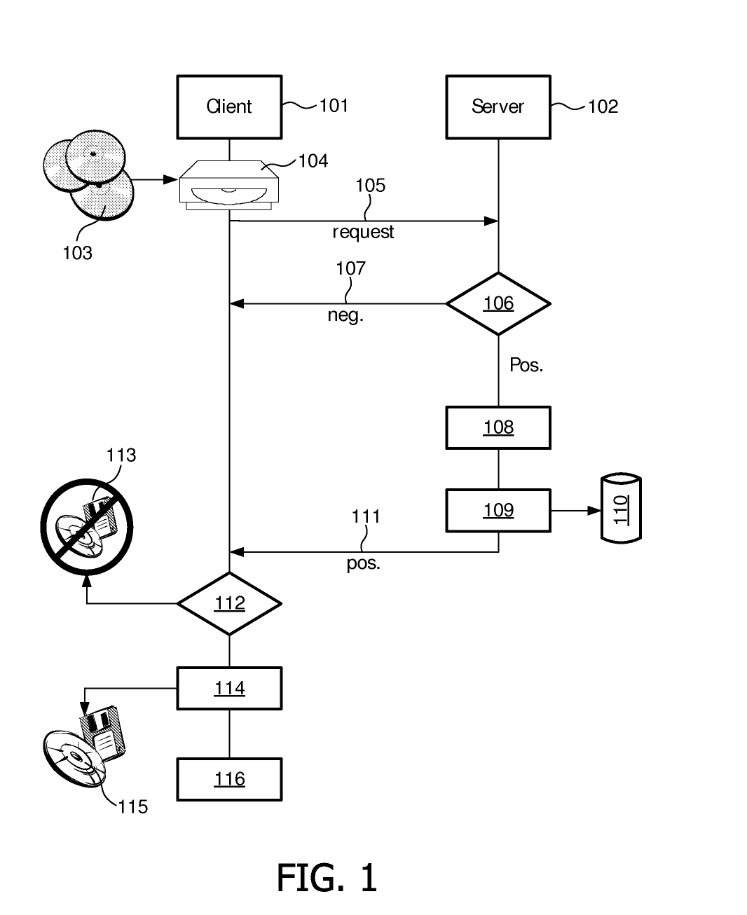

FIG. 1 illustrates an explanatory flow diagram of how the invention could be implemented and shows a client/server system where the client (101) represents the consumer, and the server (102) represents the owner of media content. The consumer has purchased an original copy (103) of the media delivered on a copy-protected media (e.g. DVD). The client can play the media on a client device (104) (e.g. DVD player). However, the consumer often wants to make another copy for personal use in order to play the media on “legacy” equipment or formats, such as PCs, CD-R discs, mp3-players, etc. The client device (104) cannot copy the original copy without permission from a server (102). The client device and server are therefore connected through a network (e.g. LAN, wireless LAN, phone, Internet, etc.), and the client device sends a request (105) to the server in order to get permission to copy the media. The request includes information about the media (e.g. a watermark) and information that identifies the customer and can e.g. be the serial number of the client device, a username and a password for an account on the server, the customer's social security number or the customer's name and address. The server decides (106) from the request and the received information whether permission to copy can be granted or not. If permission cannot be granted the server sends a negative response (107) to the client device, and the client device cannot copy the media (113). On the other hand, if permission is granted the server generates a unique watermark (108). The watermark can later be used to identify the costumer who made the copy. This is made possible by saving (109) the information that identifies the customer and the corresponding watermark in a database (110). Once the unique watermark has been generated and the corresponding information about the customer has been saved, the server sends a positive response (111) to the client device. The client device has at this point received either a negative or a positive response from the server and decides (112) whether to make a copy or not. No copy is made (113) if the response is negative. On the other hand, the client device makes a copy of the media if the response is positive, and furthermore the unique watermark received from the server is added to the copy. The result is that a new legal copy has been made (115), and the legal copy contains a unique watermark and can therefore be traced back to the customer. After the new legal copy (115) has been made, the client device deletes the information received from the server (116). This makes it impossible for a hacker to extract the unique watermark from the client device after the copy has been made because the client device only temporarily keeps information about the watermark.

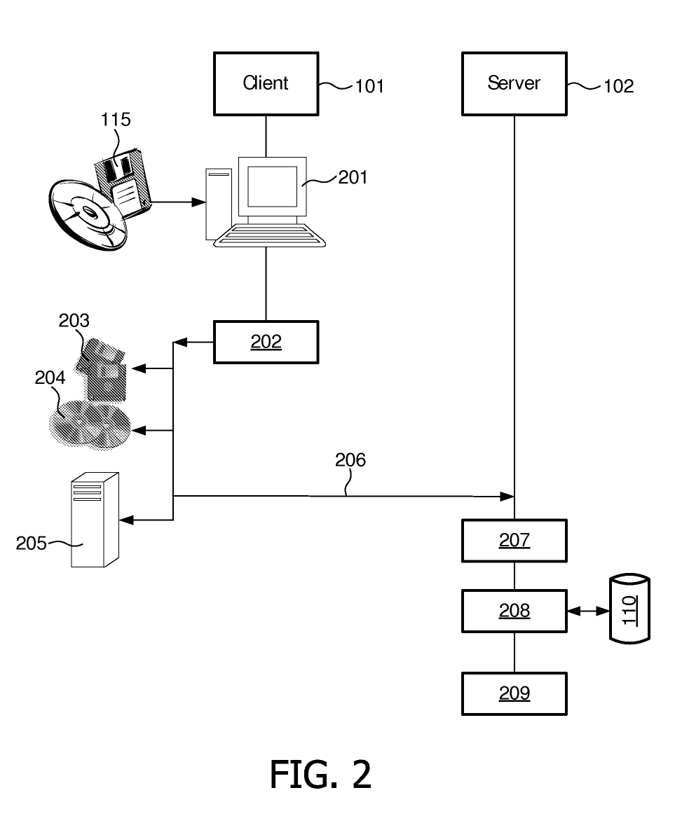

FIG. 2 illustrates an explanatory flow diagram of what eventually could happen when a consumer/client (101) has copied a copy-protected media in order to play it on “legacy” equipment or formats, such as PCs, CD-R discs, mp3-players, etc. without copy protection. The client has obtained a legal copy (115) by copying the original copy delivered on a copy-protected media as described in FIG. 1, and is now able to play it on “legacy” equipment or formats, such as PCs, CD-R discs and mp3-players (201). Unfortunately the client is also able to make more copies (202) of the media since the legal copy is not copy protected. However, these copies (203, 204, 205) would also contain the same unique watermark that was added to the legal copy (115) during the coping process described in FIG. 1. Some clients could be tempted to make many illegal copies of the media and distribute these on e.g. disks (203), CD-ROMs (204) or through an Internet server (205). The result is that many consumers could obtain an illegal copy either by receiving the copy of the media content on disks/CD-ROMs or by downloading it via the Internet. In this case the rightful owner of the media does not get proper payment for the media. Therefore, owners of media try to limit illegal distribution of their media, and this it typically done by filing a lawsuit against the consumer who distributes the illegal copies. When media has been illegally distributed, the owners/server would eventually obtain knowledge of the illegal distribution (206); this could be e.g. by receiving an illegal copy of the media. In order to file a lawsuit against the consumer responsible for the distribution, the owners need to detect who made the first copy of the legal copy (115). This is done by first extracting the unique watermark from the illegal copy (207), and once the watermark has been extracted an identification search (208) in the database (110) is performed. The database would contain information about which consumer was permitted to make the legal copy from the original copy. The result of the database search (208) is that the owner gets forensic evidence (209) of who was actively or through negligence responsible for the illegal distribution of the media.

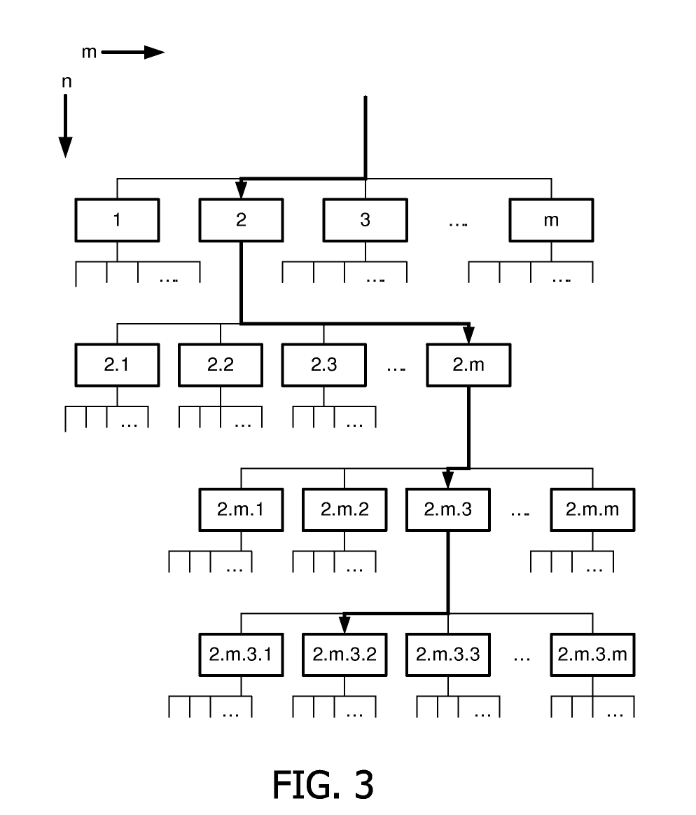

FIG. 3 illustrates how the watermarks in the present invention is structured in order to be able to obtain a series of unique watermarks and at the same time get an efficient search strategy. The watermarks are generated at a server as described in FIG. 1 as an n-level, m-array tree of unique watermark patterns. Each leaf (box) in the tree represents a unique watermark pattern and when a client device completes a transaction (makes a legal copy), it receives a unique set of watermark patterns from the web server. This set consists of the n watermark patterns that are located on a path through the tree from the root node to one of the leaf nodes. In this way it is possible to identify mⁿ individual transactions. The client device must embed all n watermarks in the copy, thus uniquely identifying the transaction that approved the copy. As an example a unique watermark is generated as a composite of several individual watermark patterns by following a path (marked with arrows) through the tree:

| | | | | | |
|---|---|---|---|---|---|
| 2 | 2.m | 2.m.3 | 2.m.3.2 | . . . | . . . |

The unique path of watermarks should only be used once so that it is possible to uniquely identify the transaction that approved the copy. The identification of a rogue copy proceeds in n steps. First, the investigator must check if the copy contains one of the m watermark patterns of the top level nodes. If this is the case, the investigator must check if the copy contains one of the m watermark patterns of the appropriate child node—and so on. If the investigator finds the watermark patterns of one of the leaf nodes, the transaction that approved the copy is identified because this watermark pattern is not shared with any other transaction. In this procedure, at most nom watermark patterns have to be checked per rogue copy. In addition, already after the first step, which comprises at most m checks, it is known whether the rogue copy may be identified at all. The unique watermark given as an example above can be identified by first searching through the top level of the tree. Here the 2-watermark is identified and the search continues to the second level of the tree, but the search is limited to the m sub-nodes below the 2-watermark. Now the 2.m-watermark is identified, and the search continues to the third level where the search is limited to the m sub-nodes below the 2.m-watermark. This process proceeds until the lowest level of the three is reached, and the unique watermark is then identified. As an example, with parameters m=128 and n=6 it is possible to support about 4·10¹² uniquely identifiable transactions, and rogue copies can be identified with at most 768 checks. In the preferred embodiment, the n watermarks are embedded throughout the copy in random locations.

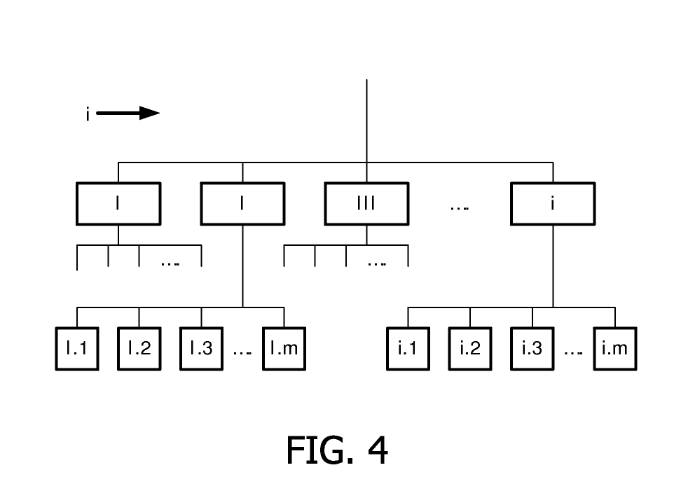

FIG. 4 illustrates an alternative embodiment of how the unique watermarks could be structured from one basic watermark sequence carrying different payloads. Unlike in FIG. 3 where each node represents introduction of an additional independent watermark pattern, in this embodiment the nodes in the first layer are defined using one basic watermark sequence generated from i different payloads whereas the watermark patterns used at the second layer are all independent. More specifically, let w₀ be the basic watermark sequence used in the first layer, then the watermark sequence at the peripheral node j,k is given by w_{i,k}=w₀[pLⱼ]+wₖ.

Where j=1 . . . i and k=1 . . . m the wₖ watermarks are independent and unique. When i=0, the above system reduces to a system where each transaction is given a strictly unique watermark pattern and detection would require search over m random sequences, where m is in the order of 10¹². On the other hand, when m=0 the above system reduces to the classical watermarking system that is based on a single basic watermark pattern. The above system thus provides a flexible watermark structure that can easily be adapted for different complexities without losing the advantage that each transaction gets a unique watermark pattern.

In order to uniquely identify a given peripheral node (watermark tracing), one has to search over m+1 patterns. First, the payload pLj is determined to identify the first layer node. Once this node is determined, search is conducted over the m patterns corresponding to the m-children of the node identified by pLⱼ. Thus, one can arbitrarily choose the values of i and m to satisfy a certain complexity requirement. It is important to note that the value of m can be as low as one, in which case the above system becomes equivalent to the classical payload based watermark system, where each watermark wₒ[pLⱼ] is masked with a one-time pad (OTP) pattern wₖ that is unique for each transaction. Here, tracing is entirely conducted using the payload carrying watermark wₒ[pLⱼ], and wₖ is used for masking purpose and for verifying the validity of the detected payload.

In one preferred embodiment, the structure of FIG. 4 can be combined with the tree structured watermark system described in FIG. 3 in order to improve the searching efficiency of the latter. This basically means replacing each node at the second layer of FIG. 4 with the tree structured watermark system shown in FIG. 3. For example, if the first layer of FIG. 4 carries a payload of 35 bits (i=235), and its second layer nodes are replaced by a tree structure of carrying 7 bits of information (a binary tree of depth 6 and a total payload of 42 bits), the number of searches to be conducted compared to that of FIG. 3 with m=128 and tree depth=6 (a total payload of 42 bits) will be reduced by the factor 128.

1. A watermark generation method for generating a watermark to be embedded in digital media, comprising combining at least two watermark patterns from a set of watermark patterns, wherein said set of watermark patterns are divided into at least two subsets of watermark patterns; said subsets being hierarchically related.

2. A watermark generation method according to claim 1, wherein said watermark patterns in said watermark are directly related watermark patterns.

3. A watermark generation method according to claim 1, wherein said watermark patterns in each of said subsets are mutually independent.

4. A watermark generation method according to claim 1, wherein said watermark patterns in at least one subset are generated by modulating a given basic pattern by a payload and at least one watermark pattern from said subset is used in the generation of said watermark.

5. A watermark generation method according to claim 1, wherein only one watermark pattern from each subset is used to generate said watermark.

6. A watermark generation method according to claim 1, wherein each combination of said watermark patterns is used only once in order to generate a unique watermark.

7. An apparatus for generation of watermarks to be embedded in digital media, said apparatus comprising means for combining at least two watermark patterns from a set of watermark patterns, wherein said set of watermark patterns are divided into at least two subsets of watermark patterns, said subsets being hierarchically related.

8. An apparatus for generation of watermarks according to claim 7, further comprising embedding means to embed said generated watermark in digital media.

9. An apparatus for generation of watermarks according to claim 8, further comprising storing means to store said watermark.
